(19) United States
(12) Patent Application Publication
(10) Pub. No.: US 2003/0202418 A1
(43) Pub. Date: Oct. 30, 2003

(54) Cementing apparatus and methods of using the same

(76) Inventor: Edward J. Scartezina, Cedar Ridge, CO (US)

Correspondence Address: TRASK BRITT, P.O. BOX 2550, SALT LAKE CITY, UT, 84110, US

(21) Appl. No.: 10/136,948

(22) Filed: Apr. 30, 2002

(51) Int. Cl. B28C 5/16

(52) U.S. Cl. 366/44; 366/51; 366/54

(57) ABSTRACT

A cementing apparatus includes a readily transportable chassis, such as that of a convention cement truck or a trailer, a rotatable mixer, a holding tank for receiving material extruded from the mixer, a pump that receives and pressurizes material from the holding tank, and an outflow conduit for directing the pressurized material to a desired location. The cementing apparatus may also include a fluid inflow system for pressurizing and directing fluid from an external source into the mixer. In addition, a valve may be positioned at an appropriate location to shut off the flow of material from the mixer through the outflow conduit and to cause fluid from an external source to flow through the outflow conduit. The apparatus may be used to mix and pump cement slurry into a drill hole through an outflow conduit and to pump displacement fluid into the drill hole through the same outflow conduit.

### BACKGROUND OF THE INVENTION

1. Field of the Invention

The present invention relates generally to apparatus used in cementing processes and, more specifically, to apparatus for use in introducing cement into well boreholes or other drill holes. In particular, the present invention relates to cementing apparatus that may be readily transported to and used at well sites to introduce cement into well boreholes or other drill holes for abandonment thereof or for cementing surface casings in place in drill holes. The present invention also relates to cementing methods, including use of the cementing apparatus.

2. Background of Related Art

As shown in FIG. 1, a typical well site may include, among other things, a well borehole 10 that has been formed in the ground G, as well as an equipment pad P and a water tank W adjacent to borehole 10. In order to minimize the impact on the environment in which the well is located, the size of the equipment pad P is typically limited. In addition, the terrain in which a well site is located may limit the size of the equipment pad P at that well site. This is particularly true at well sites that are located in remote or hard-to-reach locations.

Casings are typically provided in well boreholes to provide support to the borehole walls, preventing erosion and improving the integrity thereof. Casings also provide smooth surfaces that facilitate the introduction of equipment into and withdrawal of equipment from well boreholes.

Conventionally, at least two different methods have been used to secure so-called “surface casings”, which are located at about the uppermost 200 feet to 400 feet of a borehole, in place.

FIG. 2 depicts a first such method, in which a surface casing 20 is introduced into a partial borehole 10 or other drill hole, a substantial portion of the depth of which is to be lined with casing 20. An outer surface 22 of casing 20 is spaced apart from a wall 12 of borehole 10 around substantially the entire periphery of casing 20. Near its bottom end 24, outer surface 22 of casing 20 is provided with a basket 26, which protrudes from substantially the entire periphery of casing 20. When casing 20 is positioned within borehole 10, an outer edge 28 of basket 26 either contacts or is located in close proximity to wall 12 of borehole 10. As depicted, wall 12, outer surface 22 of casing 20, and basket 26 form a receptacle for cement. Accordingly, cement slurry 30 may be introduced, from the ground G, into the space 18 between wall 12 of borehole 10 and outer surface 22 of casing 20. Upon hardening, cement slurry 30 secures casing 20 into place within borehole 10 and, along with casing 20, prevents various substances within the earth and formations beneath ground G from escaping into borehole 10.

Another known method for securing a surface casing 20 into place within a borehole 10 is depicted in FIGS. 3A-3C. Casing 20 is again introduced into borehole 10 in such a way that an outer surface 22 of casing 20 is spaced apart from a wall 12 of borehole 10. Casing 20, however, lacks a basket. Instead, a bottom end 24 of casing 20 is positioned above and spaced apart from a bottom 14 of borehole 10. Accordingly, cement slurry 30 that is introduced into a conduit 21 formed by casing 20 and extending centrally therethrough may be forced around bottom end 24 thereof and upward into space 18 between outer surface 22 of casing 20 and wall 12 of borehole 10. Once an amount of cement slurry 30 that has been estimated to be appropriate for filling space 18 has been introduced into conduit 21, this movement of cement slurry 30 into the appropriate location may be effected by sealing an opening 11 of borehole 10 at ground G and introducing an appropriate amount of a displacement fluid 32, such as water or drilling fluid, or “mud”, into conduit 21 under sufficient pressure (often much greater than 700 psi) to cause cement 30 to move into space 18 and upward therethrough. Of course, some cement slurry 30 may also flow into cracks or “fractures” that communicate with wall 12 of borehole 10, especially under the pressures with which displacement fluids 32 are introduced into boreholes 10.

These cementing processes are typically performed by transporting various, typically bulky items of cement mixing and pumping equipment to the well site (see FIG. 1). For example, a separate batch mixer and pump may be transported to a well site to effect cementing operations at the well site. The batch mixer and the pumping equipment may be carried upon separate trailers, each of which must be transported by a 6-wheel or 10-wheel tractor, or so-called “semi”.

A conventional, down-hole cement pumping system may include a first apparatus (typically a first trailer) with containers for dry cement and other materials to be mixed therewith and a second apparatus (typically a second trailer) for forming a desired slurry of cement and/or other materials. Conduits and associated pumps or other conveyor means transport water, typically from an external tank, and cement and any other desired materials from the first apparatus of the cement pumping system to the mixer of the second apparatus of the cement pumping system. In the mixer, the water, cement, and any other materials are mixed together to form a slurry (i.e., wet cement). Such mixing typically occurs by recirculation of the materials in the mixer (i.e., repeatedly pumping the materials into and out of the mixer. Such a mixer may also include a small propeller, which may provide some additional mixing action. From the mixer, the slurry may be transported to a holding tank, which may be part of the batch mixer or separate therefrom. The holding tank is typically in communication with a pumping mechanism, which is typically electrically operated (typically by way of a diesel engine and a generator), that may be carried on the same support as the batch mixer or separately therefrom. The pumping mechanism transports the slurry from the holding tank into the borehole.

In addition to being quite bulky and, thus, consuming a significant amount of the space on an equipment pad at a well site, due to the size of the mixers and pumps of conventional down-hole cement pumping systems, operation of such systems typically requires at least four people. Of course, the man power needed to operation such cement pumping systems is closely related to the cost of cementing operations, as each person must be paid for their time in setting up and operating a conventional down-hole cement pumping system.

Further, conventional down-hole cement pumping systems are typically difficult to clean. This is due, at least in part, to the complex systems of pumps and conduits of such devices. Typically, it takes as long as three hours or longer to clean a conventional down-hole cement pumping system.

As the cementing equipment that is used at a well site is typically very large, a substantial portion, if not all, of the area on the equipment pad P at the well site is consumed by such cementing equipment, which often results in the requirement that operation of other equipment being used at the well be ceased and that such other equipment be removed from the equipment pad P. The cessation of other well-related operations and removal of associated equipment from the equipment pad P is particularly undesirable since conventional well-cementing equipment requires a significant amount (e.g., an hour or more) setup time before the cementing operation may even begin. Likewise, a significant amount of time is typically required to disassemble conventional cementing equipment and to transport the same from the equipment pad P.

Consequently, conventional well-cementing operations typically consume a great deal of valuable time at the expense of other processes that could be conducted immediately before or after a cementing operation.

The inventor is not aware of any portable cementing apparatus that include mixing and pumping features on a single chassis that would consume only a small portion of an equipment pad at a well site and which could be readily set up and used without substantially interfering with other processes occurring at the well site.

### SUMMARY OF THE INVENTION

The present invention includes portable cementing apparatus and methods for using the portable cementing apparatus.

Portable cementing apparatus according to the present invention include, among other things, a readily transportable chassis upon which a mixer and a pump are carried. By way of example only, the chassis may comprise the chassis of a truck, such as that of a standard cement mixer, or the chassis of a trailer.

As a slurry is extruded from the mixer, it is introduced into a holding tank which, in turn, communicates with an ejection hose. The pump, which also communicates with the ejection hose, causes slurry within the holding tank to be withdrawn therefrom, transported along the length of the hose, and ejected therefrom. Additionally, the portable cementing apparatus may include various gauges for monitoring the amount of slurry pumped from the holding tank and the pressure under which the slurry is being pumped.

Water or other fluids may be introduced into the mixer of the cementing apparatus by way of a spray system coupled to a first end of a fluid inlet hose. The spray system is oriented to direct fluid toward locations within the mixer at which dry cement is likely to be located or accumulate. The force with which the spray system directs fluid may be sufficient to loosen and, thus, remove accumulated, or “pancaked”, dry cement or very thick slurry from interior surfaces of the mixer, such as a lower end of the mixing drum. The second end of the fluid inlet hose may be configured to communicate with an external fluid source, such as an onsite water storage tank. One or more gauges may communicate with the hose to facilitate evaluation of the pressure with which fluid is introduced into the mixer and of the volume of fluid introduced into the mixer.

A portable cementing apparatus incorporating teachings of the present invention may be used in variety of different applications. For example, the portable cementing apparatus may be transported to a well site, at which the portable cementing apparatus may be used to cement a surface casing in place at an upper end of a drill hole (e.g., a borehole of the well), to cement casings in place at deeper locations of a drill hole, to fill the well for purposes of abandonment thereof, or otherwise, as known in the art. Since the mixing and pumping components of the portable cementing apparatus are included on a single chassis, all of the elements necessary for a cementing operation can be readily transported to the well site, even to well sites at remote or hard-to-reach locations. As the portable cementing apparatus is a substantially self-contained unit, once the cementing apparatus has reached a well site, it may be readily set up, merely requiring connection of a fluid inlet hose to an external fluid source at the well site, introduction of fluid into the mixer, mixing of fluid with concrete predisposed within the mixer, and positioning of the ejection hose for introduction of slurry into the borehole. Also, a portable cementing apparatus of the present invention may be used at a well site without consuming a considerable amount of space on the equipment pad thereof. Accordingly, other well-related operations may continue, substantially uninterrupted, as the portable cementing apparatus is being set up and taken down.

Other features and advantages of the present invention will become apparent to those of ordinary skill in the art through consideration of the ensuing description, the accompanying drawings, and the appended claims.

### BRIEF DESCRIPTION OF THE DRAWINGS

In the Figures, which depict exemplary embodiments of various aspects of the present invention:

FIG. 1 is an illustration of a typical well site;

FIG. 2 is a sectional view depicting a portion of a drill hole and an exemplary method for cementing a surface casing in place within the drill hole;

FIGS. 3A-3C are sectional representations of a drill hole that depict another exemplary method for cementing a surface casing in place within the drill hole;

FIG. 4 is a rear view of an exemplary embodiment of a cementing apparatus incorporating teachings of the present invention, in which the chassis by which the mixer and pump are carried comprises a truck chassis;

FIG. 5 is a partial side view of the cementing apparatus shown in FIG. 4;

FIG. 6 is a schematic representation of a side view of another exemplary embodiment of cementing apparatus according to the present invention, including a mixer and pump that are carried by a trailer chassis;

FIG. 7 is a schematic, cross-sectional representation of a drill hole, depicting an exemplary cementing process according to the present invention; and

FIG. 8 is a schematic, cross-sectional representation of a drill hole, illustrating an exemplary process for abandonment thereof.

### DETAILED DESCRIPTION

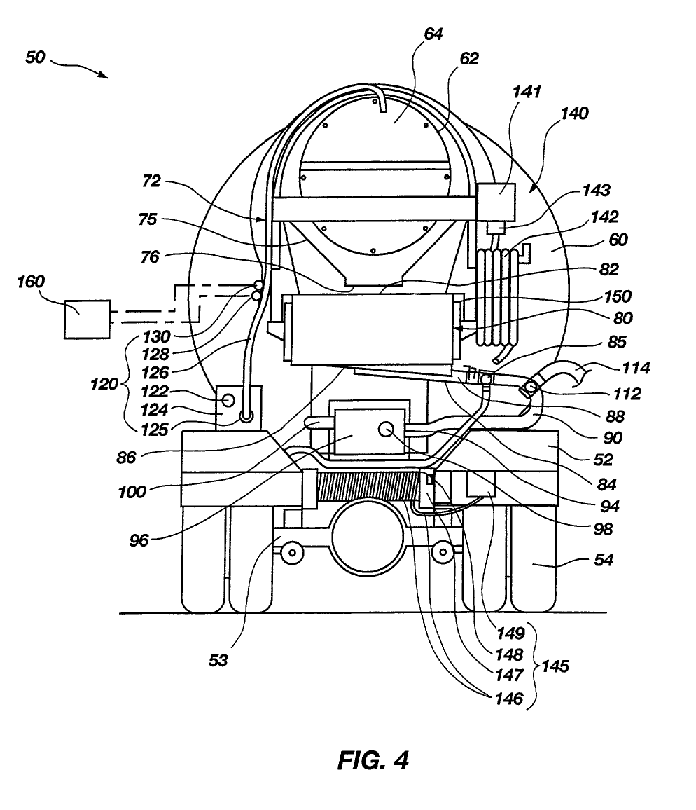

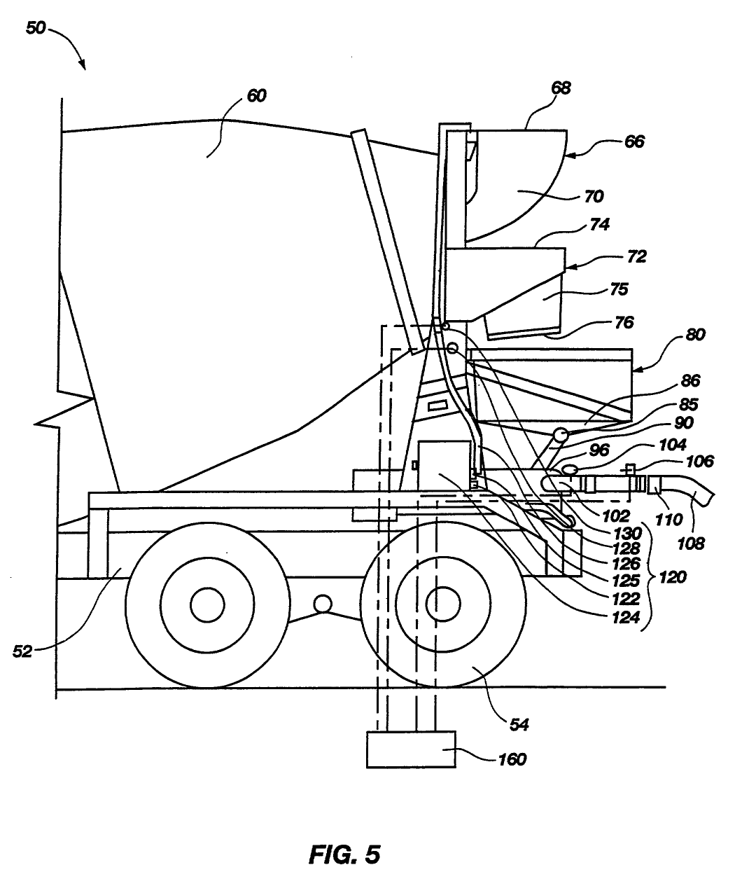

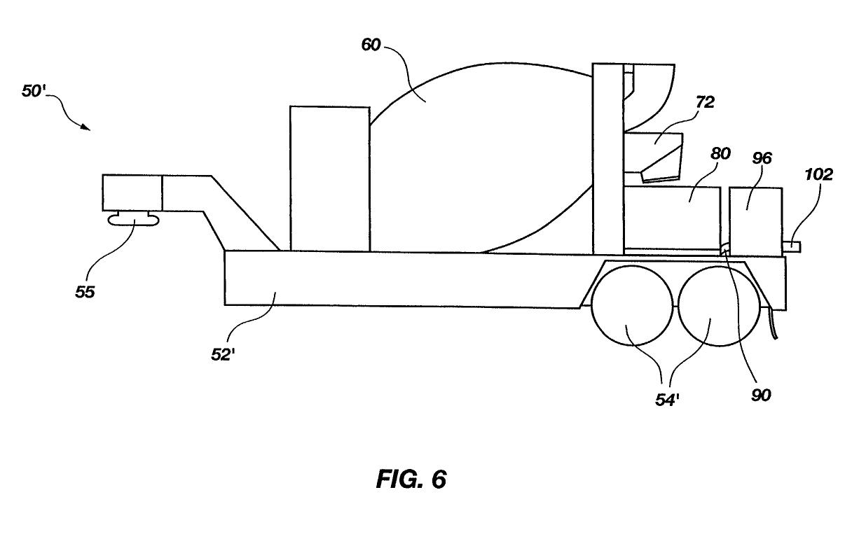

As depicted in FIGS. 4 and 5, a first exemplary embodiment of cementing apparatus 50 of the present invention includes the chassis 52 of a conventional cement mixer truck. Axles 53 and wheels 54 are operatively coupled to chassis 52, as known, to facilitate the ready transportation of cementing apparatus 50. Chassis 52 of cementing apparatus 50 carries both a mixer 60 and a pump 80. Various additional elements of cementing apparatus 50 will be described hereinafter in further detail.

Mixer 60 of cementing apparatus 50 is a conventional mixer, such as a rotating, drum type mixer, which may be coupled to chassis and operate in a known manner. Mixer 60 includes an interior (not shown) that is configured to facilitate both mixing and extrusion, depending upon the direction in which mixer 60 is rotated. An opening 62 of mixer, located near the uppermost portion thereof, facilitates the introduction of materials into and the removal of materials from the interior of mixer 60.

As depicted in FIG. 4, opening 62 may be fitted with a cover 64 to prevent the loss of materials within mixer 60, particularly when cementing apparatus 50 is being transported uphill (when opening 62 of mixer 60 is located at or proximate the rear of cementing apparatus 50) or downhill (when opening 62 of mixer 60 is located at or proximate the front of cementing apparatus 50). Additionally, cover 64 may prevent unwanted materials, such as water, from entering the interior of mixer 60 through opening 62. Cover 64 may comprise a rigid member that will withstand and remain in place under the force of materials being bounced around within mixer 60, including the forces with which materials may be pushed against cover 64 as cementing apparatus 50 is being transported uphill or downhill. Alternatively, cover 64 may comprise a flexible, waterproof member that will withstand the various conditions (e.g., rain, wind, heat, etc.) of the environment within which cementing apparatus 50 is to be used and, possibly, stored for prolonged periods of time. In either event, cover 64 may be readily removed from opening 62 to facilitate the introduction of material into the interior of mixer 60, as well as the extrusion of material therefrom.

The introduction of material, such as dry cement, into mixer 60 may be facilitated by way of a hopper 66, shown in FIG. 5, that communicates with or that may be positioned to communicate with an upper portion of opening 62. Hopper 66, which may be of a conventional configuration, includes a somewhat upwardly facing opening 68 and a hollow interior (not shown) that communicates materials from opening 68 to an opposite end of hopper 66 to introduce such materials into opening 62 of mixer 60. The interior of hopper 66 and, particularly, a bottom surface 70 thereof may be configured to direct materials, such as dry cement, into opening 62 of mixer 60 in a relatively smooth manner.

Optionally, cementing apparatus 50 may include a fluid inflow system 120, which is configured to introduce fluids, such as water, from an external fluid source (not shown), such as an on-site water tank, into mixer 60. Fluid inflow system 120 may include a fluid inlet 122, which is configured to be coupled with a hose or other conduit (not shown) that communicates with the external fluid source. Also, fluid inflow system 120 may include a pump 124, of which fluid inlet 122 may be a part, to generate a positive pressure for moving the fluid through the remainder of fluid inflow system 120. Such a pump 124 may also generate a negative pressure at fluid inlet 122 and, thus, within a hose or other conduit coupled therewith, which may draw fluid into fluid inflow system 120. Alternatively, or in addition, the force of gravity on fluid within the external fluid source may cause fluid to flow therefrom into fluid inflow system 120 once flow communication is established between the external fluid source and fluid inflow system 120. The rate at which such a pump 124 operates, as well as the pressure generated by such a pump may, of course, be controlled. By way of example only, pump 124 may pressurized fluid introduced therein a pressure of about 300 psi or greater. Fluid inflow system 120 also includes a conduit 126, such as a hose, which may be coupled directly to fluid inlet 122 if fluid inflow system 120 does not include a pump or, if fluid inflow system 120 does include a pump 124, to a fluid outlet 125 of pump 124. Conduit 126 extends from fluid inlet 122 or fluid outlet 125 to opening 62 of mixer 60 and, thereby, facilitates the movement of fluid, under pressure within conduit 126, into the interior of mixer 60. Conduit 126 may be oriented to direct fluid toward areas within the interior of mixer 60 at which dry materials are likely to collect, or “cake”. A flow or volume gauge 128, such as a turbine flow meter or a type known in the art or a magnetic volume gauge, may be positioned at any point along the flow path of fluid inflow system 120 to facilitate measurement of an amount of fluid introduced into mixer 60. A pressure gauge 130 may likewise be positioned at any point along the flow path of fluid inflow system 120 to measure fluid pressure within fluid inflow system 120.

A collector 72 is positioned adjacent to and in communication with a bottom portion of opening 62 of mixer 60. Collector 72 is configured to receive materials, such as a cement slurry, that are extruded from the interior of mixer 60 as mixer 60 is rotated in the appropriate direction and to direct such materials into a temporary holding tank 80 of cementing apparatus 50. Accordingly, collector 72 may include a somewhat upwardly facing receptacle 74, which is positioned beneath opening 62 to receive, or catch, materials as they are extruded from the interior of mixer 60. Gravity may cause the extruded materials to fall into receptacle 74. Collector 72 may also include a funneling portion 75 that leads to a smaller, somewhat downwardly facing outlet 76, through which the material exits collector 72.

As material, such as a cement slurry, exits outlet 76 of collector 72, it is introduced (e.g., by gravity) into an inlet 82 of temporary holding tank 80, which is depicted as being located beneath collector 72. Alternatively, temporary holding tank 80 may be positioned elsewhere on cementing apparatus 50, in which case material may be transported from outlet 76 of collector 72 to inlet 82 of temporary holding tank 80 through a hose or other conduit (not shown) positioned therebetween. A pumping system (not shown) of a known type may also be used to facilitate the movement of material from outlet 76 of collector 72 to inlet 82 of temporary holding tank 80.

As depicted, an interior of temporary holding tank 80 communicates with an exit port 84. A bottom portion of the interior of temporary holding tank 80 may be configured to direct substantially all of the material within temporary holding tank 80 to exit port 84 thereof. As depicted in FIG. 4, and solely by way of example, temporary holding tank 80 may have a slanted bottom 86. In the depicted example, exit port 84 is located at a lowermost portion of temporary holding tank 80. Gravity forces the material along slanted bottom 86 of holding tank 80 to facilitate the removal of substantially all of the material therefrom through exit port 84 thereof.

Exit port 84 of temporary holding tank 80 may be configured to be coupled with a first end 88 of a transport hose 90 or other intermediate conduit. The second, opposite end 92 of transport hose 90 is configured to be coupled with a pump 96 of a known type. Material from temporary holding tank 80 may, therefore, be transported to pump 96 through transport hose 90. A valve 85, such as ball valve, may be positioned adjacent to exit port 84 or along transport hose 90 to provide an operator of cementing apparatus 50 with control of the flow of material from temporary holding tank 80 to pump 96.

Pump 96 includes, among other things, an inlet 94 and an outlet 98. Pump 96 is operably coupled to a driver 100, such as a motor or engine of a suitable, known type. Driver 100 causes pump 96 to operate. By way of example only, pump 96 may comprise a so-called “triplex piston pump” or “triplex plunger pump” of a type known in the art, such as those available from FMC Corporation of Philadelphia, Pa. Such pumps are capable of pumping cement slurries at rates of up to about 120 gallons per minute or more and at pressures of up to about 1,200 psi and greater. Driver 100 of such a pump 96 may comprise a hydraulic motor, which may be operably coupled with a transmission of the cement truck (e.g., by way of a power take-off, as known in the art), or an electric motor.

As pump 96 operates, a negative pressure may be generated at inlet 94 and, thus, within a transport hose 90 in communication with inlet 94. This negative pressure may draw material from temporary holding tank 80 into transport hose 90 and, thus, be at least partially responsible for the movement of material from temporary holding tank 80 into transport hose 90. Also, the operation of pump 96 forces material therein through outlet 98 thereof. Thus, pump 96 generates a positive pressure at outlet 98, as well as within an outflow conduit 102 in flow communication with outlet 98.

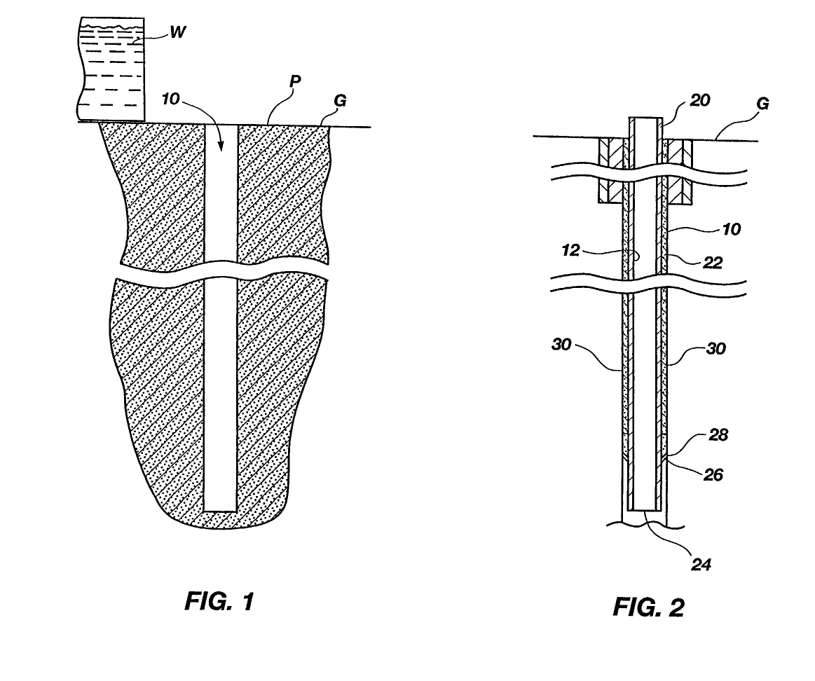

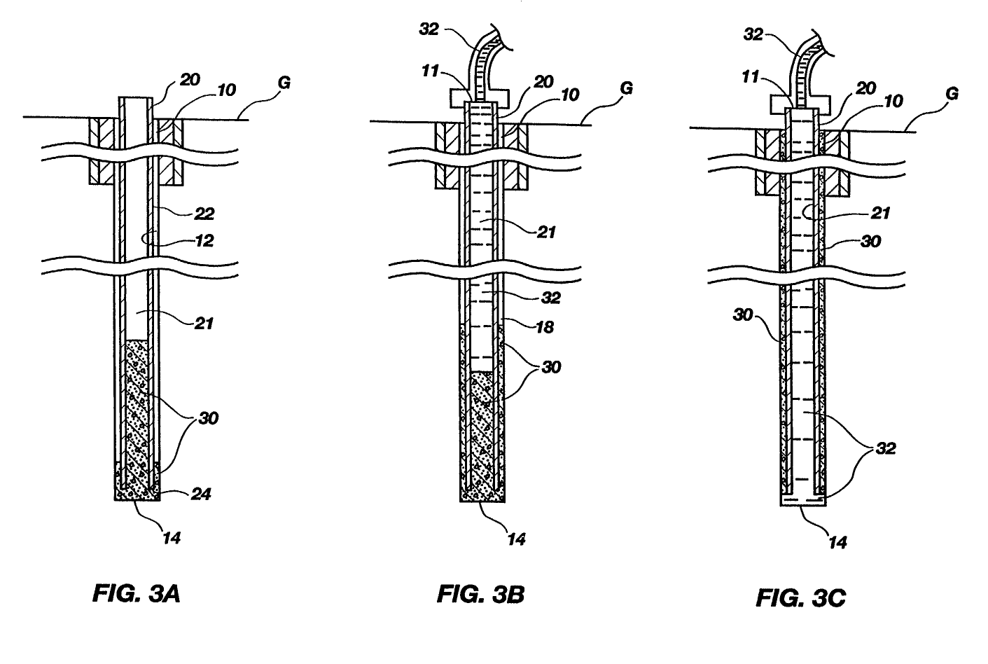

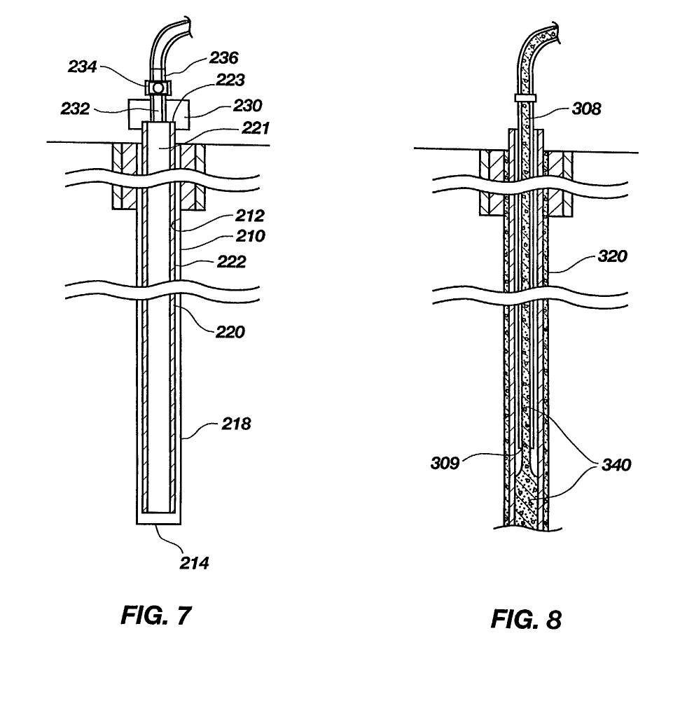

A first end 110 of another conduit, such as an outflow hose 108, may be removably coupled with outflow conduit 102. Outflow hose 108 has a length that facilitates the movement of material, such as a cement slurry, to a desired location, such as drill hole comprising a methane vent of a coal mine, a well, or the like, at which material is expelled from a second, opposite end (not shown) of outflow hose. By way of example, the second end of outflow hose 108 may be introduced into a space 18 (FIG. 1) between a wall 12 of a drill hole 10 and an outer surface 22 of a casing 20 that has been positioned within drill hole 10. As another example, the second end of outflow hose 108 may be coupled to a cover 230 disposed over a casing 220 within a drill hole 210, as described in further detail hereinafter with reference to FIG. 7.

A pressure gauge 104, a flow gauge 106, or a combination thereof may be positioned along outflow conduit 102 or along an outflow hose 108 or other conduit that may be coupled with outflow conduit 102. A pressure gauge 104 is useful for measuring the pressure under which material is being pumped, which may be indicative of conditions of the environment (e.g., a drill hole, such as the borehole of a well) into which material is being pumped. Measurements obtained by a flow gauge 106 (e.g., an ultrasonic flow gauge), such as the Doppler flow meter, model no. SX30-16A, available from Polysonics of Houston, Tex., are useful for determining an amount, or volume, of material that has been pumped into or through outflow conduit 102 or outflow hose 108.

As shown in FIG. 4, cementing apparatus 50 may also include a chemical injection system 140 for introducing chemicals into either mixer 60 or into a drill hole. As depicted, chemical injection system 140 may include a chemical source 141, such as a tank, that has been secured to another stationary feature of cementing apparatus 50, as well as a chemical introduction conduit 142 through which chemicals may be transported from chemical source 141 and into either mixer 60, through opening 62 thereof, or directly into a drill hole. Chemical injection system 140 may also include an injection element 143, such as a fluid pump or other injection apparatus known in the art and suitable for the form (i.e., liquid, solid, etc.) of chemical to be introduced into mixer 60. As illustrated, injection element 143 may be positioned at an end of or along the length of chemical introduction conduit 142. As an example of the use of chemical injection system 140, calcium chloride, which generates heat and, thus, reduces the cure time of the cement into which it is mixed, may be introduced into either mixer 60 or directly into a drill hole. As another example of the use of chemical injection system 140, sodium silicate, which also reduces the cure time of cement, may be introduced directly into a drill hole (not shown) through chemical introduction conduit 142.

With continued reference to FIG. 4, cementing apparatus 50 may also be equipped with a sensor introduction system 145 with which one or more sensors 149 may be introduce into a drill hole. As depicted, sensor introduction system 145 includes a winch 146 for receiving a cable 147 of suitable functionality (e.g., a computer or other electrical cable, a fiber optic cable, a combination electrical and fiber optic cable, or the like) and length, as well as for releasing a desired length of cable 147 to facilitate introduction thereof and one or more sensors 149 secured to an end thereof, into a drill hole. Another end of cable 147 may communicate with a connector 148 of a known type, which may be configured to be coupled with an appropriate monitoring apparatus, such as a computer 160. In this manner, sensor introduction system 145 may facilitate monitoring of one or more down-hole conditions.

Optionally, cementing apparatus 50 may include one or more mounting brackets 150 for removably securing additional equipment, such as a chute (not shown), to cementing apparatus. As depicted, mounting brackets 150 may be positioned to locate such additional equipment beneath collector 72 and over temporary holding tank 80 so as to receive and direct the flow of material, such as sand, gravel, cement, mortar, concrete, or the like, that has been extruded from mixer 60, while preventing such material from flowing into temporary holding tank 80. By way of example only, if mounting brackets 150 are used to secure a conventional cement chute to cementing apparatus 50, a material that could damage pump 96, such as gravel, may be extruded from mixer 60 and directed to a desired location (e.g., into a drill hole 210, such as that depicted in FIG. 7) without having to flow through the remainder of cementing apparatus 50.

With reference to FIG. 6, another embodiment of cementing apparatus 50 that incorporates teachings of the present invention is depicted. Cementing apparatus 50 includes a readily transportable chassis 52 in the form of a trailer, such as that configured to be coupled to and transported by way of so-called “tractor” or “semi”. Chassis 52 includes wheels 53 and a coupling component 54 configured to couple chassis 52 to a vehicle, as known in the art. Cementing apparatus 50 also includes a rotatable mixer 60, a collector 72, a temporary holding tank 80, a transport hose 90 or other intermediate conduit, a pump 96, and an outflow conduit 102, as described above with reference to FIGS. 4 and 5. Cementing apparatus 50 may also include additional elements, as described above with reference to FIGS. 4 and 5.

Turning now to FIG. 7, an exemplary use of a cementing apparatus 50, 50 (see FIGS. 4, 5, and 6 for detail of cementing apparatus 50, 50) that incorporates teachings of the present invention is depicted. In FIG. 7, a cross-sectional representation of a drill hole 210 is shown. A surface casing 220 has been introduced into drill hole 210, with at least some locations of an outer surface 222 of surface casing 220 being spaced apart from a wall 212 of drill hole 210. In addition, a cover 230 is positioned and sealed over an upper end 223 of surface casing 220, as known in the art. Cover 230 includes an aperture 232 therethrough to facilitate the introduction of cement and water or another liquid (e.g., drilling fluid, or “mud”), into a conduit 221 that extends centrally through the length of surface casing 220. Aperture 232 is configured to be coupled with a ball valve 234 of a known type, which may be configured to control the introduction of materials, such as a cement slurry, drilling fluid, or water, through cover 230 and into conduit 221 of surface casing 220. Ball valve 234 includes a coupling element 236 (e.g., a nipple of a known type) for receiving a hose, such as outflow hose 108 (FIGS. 4 and 5), through which material, such as cement slurry, drilling fluid, or water, may be transported.

A cement slurry may be formed and pumped into conduit 221 of surface casing 220 and, thus, into drill hole 210 by use of cementing apparatus 50, 50 (FIGS. 4, 5, and 6). Once a desired amount of cement slurry (e.g., a precalculated amount of cement slurry, based on the depth and size of the drill hole 210 and an estimated amount of cement slurry that will be lost in fractures along walls 212 of drill hole 210) has been introduced through ball valve 234, cover 230, and conduit 221 of surface casing 220 and to a bottom 214 of drill hole 210, water, drilling fluid, or another displacement fluid may be introduced into drill hole 210.

By way of example only, with returned reference to FIGS. 4, 5, and 6, as well as with continuing reference to FIG. 7, the introduction of a displacement fluid into mixer 60, 60 may be continued, as may the flow of the displacement fluid through the remaining components of cementing apparatus 50, 50. Accordingly, the displacement fluid may be introduced into drill hole 210 through the same hose (e.g., outflow hose 108) as that through which the cement slurry was introduced into drill hole 210. Also, if water or another suitable cleaning liquid is used as the displacement fluid and is run through cementing apparatus 50, 50 following the introduction of a cement slurry into drill hole 210, cementing apparatus 50, 50 may be cleaned as the water is introduced into the drill hole 210.

As another example, and with continued reference to FIGS. 4-7, a valve 112 of cementing apparatus 50, 50 may be disposed along transport hose 90, on pump 96, or along outflow hose 108. Actuation (e.g., switching) of valve 112 may stop the flow of a cement slurry through cementing apparatus 50, 50 and facilitate the flow of a suitable displacement fluid (e.g., water, drilling fluid, or another suitable liquid) from an external source (not shown), through a fluid introduction conduit 114, into valve 112, and into transport hose 90, pump 96, or outflow hose 108 of cementing apparatus 50, 50. Accordingly, actuation of valve 112 may also facilitate the introduction of water, drilling fluid, or another suitable liquid into drill hole 210 through ball valve 234, cover 230, and conduit 221 of surface casing 220 without requiring the removal of a hose (e.g., outflow hose 108, 108) from cover 230 (e.g., from coupling element 236 of ball valve 234) and the coupling of another hose thereto.

In any event, the displacement fluid may be introduced through cover 230 and into conduit 221 of casing 220 and drill hole 210 within which casing 220 is positioned at a pressure of about 700 psi or less and as low as about 340 psi. The introduction of displacement fluid into drill hole 210 at such pressures facilitates movement of the cement slurry into a space 218 between an outer surface 212 of casing 220 and wall 212 of drill hole 212, while permitting drilling fluid, or mud, which has been introduced into fractures that are continuous with wall 212 to prevent the cement slurry from entering such fractures and becoming lost or entering undesired locations of the drilled formation (e.g., an underlying coal mine).

Alternatively, a cementing apparatus 50, 50 incorporating teachings of the present invention may be used to cement a casing 20 in place relative to a drill hole 10 by the method described in FIGS. 1 and 2. Either type of cementing operation may be conducted in as little as about 45 minutes from when introduction of surface casing 20, 220 into drill hole 10, 210 begins.

Cementing apparatus 50, 50 may also be used to cement casings into deeper locations of drill holes, as known in the art.

As another example of the use of cementing apparatus 50, 50, shown in FIG. 8, a suitable cement slurry may be mixed and pumped into a drill hole 320 to fill at least a portion thereof for abandonment of drill hole 320. A length of trimme tubing 308, which communicates with outflow conduit 102 (FIGS. 4-6) of cementing apparatus 50, 50, may be introduced into drill hole 320, about 50 feet from the bottom thereof. A cement slurry 340 is then mixed and pumped by cementing apparatus 50, 50, pumped through trimme tubing 308, and, thus, introduced into drill hole 320. Once the portion of drill hole 320 beneath trimme tubing 308 has been filled, cement slurry 340 will begin to collect at the bottom 309 of trimme tubing 308, thereby increasing the pressure within trimme tubing 308 and outflow conduit 102 (FIGS. 5 and 6). As this increase in pressure is noted, for example, at pressure gauge 106 (FIGS. 4 and 5), trimme tubing 308 may be partially withdrawn (e.g., a distance of about 50 feet) from drill hole 320. This process may be repeated until drill hole 320 has been substantially filled with cement slurry 340.

Referring again to FIGS. 4-6, when a cementing apparatus 50, 50 of the present invention is being used, the fluid flow through and the fluid pressure within various components of cementing apparatus 50, 50 may be evaluated, either manually or automatically. Such evaluation of pressure and flow may provide information about the conditions of the environment (i.e., a drill hole) into which material is being introduced, either with or without accompanying monitoring of conditions within the environment. Such information may, in turn, be useful to an operator of cementing apparatus 50, 50 in terms of the operator's controlling the cementing operation in such a way as to minimize the amount of cement slurry being used in the cementing operation.

As an example of manual monitoring of pressure and flow, gauges 104, 106, 128, 130 or any combination thereof may be located and oriented so as to be readily viewed by a single operator at a particular location relative to cementing apparatus 50, 50. Additionally, the orientation of one or more of gauges 104, 106, 128, 130 may be adjustable so as to facilitate viewing thereof by a single operator of cementing apparatus 50, 50 while the operator is at a particular location relative to cementing apparatus 50, 50. If any of the gauges 104, 106, 128, 130 indicates that the flow or pressure or some combination thereof does not reach a minimum threshold or exceeds a maximum threshold, the operator may take the appropriate action by adjusting an appropriate element of cementing apparatus 50, 50. By way of example only, once a desired amount of water has been introduced into mixer 60, pump 124 of fluid inflow system 120 may be shut off. As another example, if the fluid pressure at outflow conduit 102 or outflow hose 108 becomes too low or too high (i.e., is less than a minimum threshold or exceeds a maximum threshold), or if a sudden increase or decreasing in the fluid pressure occurs, the movement of displacement fluid or cement slurry through outflow conduit 102 or outflow hose 108 may be slowed or terminated. For example, the rate of operation of pump 96 may be slowed or pump 96 may be turned off and the rate at which mixer 60 is rotated may be slowed or mixer 60 may be rotated in the opposite, mixing direction. Likewise, when flow gauge 106 indicates that at least a sufficient amount of cement slurry has been expelled by cementing apparatus 50, 50 to perform the desired operation, pump 96 may be shut down and the rotation of mixer 60 reversed. If the amount of cement slurry that has been expelled by cementing apparatus exceeds an amount that was previously calculated to be sufficient for completing the desired cementing operation, operation of cementing apparatus 50, 50 may likewise be slowed or terminated so that the conditions within a drill hole may be evaluated in an attempt to determine the cause of the need for additional cement slurry. Accordingly, a cementing apparatus 50, 50 according to the present invention may be configured for operation by a single individual at a single location, from which the various systems of cementing apparatus 50, 50 may be operated and cementing processes may be monitored.

Pressure and flow may be automatically monitored by way of a computer 160 that communicates with each gauge 104, 106, 128, 130 of cementing apparatus 50, 50. Computer 160 may be configured to instruct an operator of cementing apparatus 50, 50 to take certain actions in response to measurements at one or more gauges 104, 106, 128, 130. Alternatively, computer 160 may communicate with and control various elements of cementing apparatus 50, 50, in which case computer 160 may effect changes in the manner in which materials flow through various elements of cementing apparatus 50, 50 responsive to measurements at one or more gauges 104, 106, 128, 130 thereof.

Once use of a cementing apparatus 50, 50 according to the present invention is complete, water or another suitable cleaning fluid may be introduced into mixer 60, 60 thereof and permitted to flow through the remaining elements of cementing apparatus 50, 50. Water or another suitable cleaning fluid may alternatively or additionally be introduced into transport tube 90, pump 96, and/or outflow conduit 102/outflow hose 108 from external fluid source (not shown) and through fluid introduction conduit 114 by actuation of valve 112. The cleaning process may be effected in as little as 20 minutes or less.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. Cementing apparatus, comprising:
a single, readily transportable chassis;
a rotatable mixer supported by said chassis;
a holding tank supported by said chassis and positioned to receive material from said mixer;
an intermediate conduit in communication with said holding tank and configured to transport said material therefrom;
a pump in communication with said conduit, said pump configured to pressurize said material; and
an outflow conduit in communication with said pump, said outflow conduit configured to at least partially direct said material to a desired location.

2. The cementing apparatus of claim 1, wherein said readily transportable chassis comprises a truck chassis.

3. The cementing apparatus of claim 1, wherein said readily transportable chassis comprises a trailer chassis.

4. The cementing apparatus of claim 1, wherein said rotatable mixer is configured to:
mix materials therein when rotated in a first direction; and
extrude materials therein when rotated in a second direction, opposite said first direction.

5. The cementing apparatus of claim 1, wherein said pump is hydraulically operated.

6. The cementing apparatus of claim 1, further comprising a fluid inflow system oriented to introduce fluid material into an interior of said rotatable mixer.

7. The cementing apparatus of claim 6, wherein said fluid inflow system is configured to communicate with a source of fluid material separated from the cementing apparatus.

8. The cementing apparatus of claim 1, further comprising:
at least one flow gauge in communication with at least one of said pump and said outflow conduit; and
at least one pressure gauge in communication with at least one of said pump and said outflow conduit.

9. The cementing apparatus of claim 8, wherein said at least one flow gauge and said at least one pressure gauge are oriented to be viewed by an operator of the cementing apparatus from a location at which the operator is able to control operation of the cementing apparatus.

10. The cementing apparatus of claim 1, further comprising:
at least one mounting bracket for removably securing a chute beneath an opening of said mixer from which material is extruded and above an opening of said holding tank.

11. The cementing apparatus of claim 1, further comprising:
a valve in communication with at least one of said intermediate conduit, said pump, and said outflow conduit; and
a fluid introduction conduit in communication with an external fluid source and said valve, said valve being positionable to permit substantially only one of material from said mixer and fluid from said external fluid source from being expelled from said outflow conduit.

12. A method for cementing a surface casing in place within a drill hole, comprising:
inserting the surface casing into the drill hole;
positioning and sealing a cover over an upper edge of the surface casing;
coupling a conduit to said cover so as to facilitate fluid communication between said conduit and an interior of the surface casing;
introducing a cement slurry into the interior of the surface casing and a bottom of the drill hole through said conduit and said cover; and
without removing said conduit from said cover, introducing a displacement fluid into the interior of the surface casing and the bottom of the drill hole through said conduit and said cover.

13. The method of claim 12, wherein said introducing displacement fluid comprises forcing said cement slurry upward into a space between an outer surface of the surface casing and a wall of the drill hole.

14. The method of claim 12, wherein said introducing said cement slurry and said introducing said displacement fluid are effected by a single pump.

15. The method of claim 14, further comprising:
actuating a valve in communication with said conduit to substantially prevent additional cement slurry from a cementing apparatus from being introduced into said conduit and to permit said displacement fluid to flow into said conduit.

16. The method of claim 15, wherein said actuating said valve includes permitting said displacement fluid to flow from a fluid source external to the cementing apparatus.

17. A cementing method, comprising monitoring flow and pressure of a cement slurry being pumped by a cementing apparatus from the same location of said cementing apparatus as that from which mixing and pumping of said cement slurry by said cementing apparatus is controlled.

18. The cementing method of claim 17, wherein said monitoring is effected by viewing at least one pressure gauge and at least one flow gauge from said single location.

19. The cementing method of claim 17, wherein said monitoring is also effected at the same location of said cementing apparatus as that from which pumping of a displacement fluid is controlled.

20. The cementing method of claim 19, further comprising:
slowing or ceasing mixing and pumping of at least one of said cement slurry and said displacement fluid into a drill hole when said monitoring indicates a drop in pressure below a minimum threshold or an increase in pressure above a maximum threshold.

21. The cementing method of claim 19, wherein said monitoring comprises evaluating at least one condition within a drill hole into which at least one of said cement slurry and said displacement fluid is being pumped by said cementing apparatus.
